(19) United States
(12) Patent Application Publication
(10) Pub. No.: US 2026/0260035 A1
(43) Pub. Date: Sep. 3, 2026

(54) ROLLING CORRECTION INTELLIGENT IRRIGATION DECISION-MAKING METHOD FOR REGIONAL WHEAT-CORN ROTATION SYSTEM

(71) Applicant: Northeast Agricultural University, HarBin (CN)

(72) Inventors: Mo LI, HarBin (CN); Shiyu WEI, HarBin (CN); Qiang FU, HarBin (CN); Lili ZHANGZHONG, HarBin (CN); Yijia WANG, HarBin (CN); Wenhao DONG, HarBin (CN); Ziqiang SUN, HarBin (CN)

(73) Assignee: Northeast Agricultural University, HarBin (CN)

(21) Appl. No.: 19/531,426

(22) Filed: Feb. 5, 2026

(30) Foreign Application Priority Data
Feb. 28, 2025 (CN) 202510231728.3

(51) Int. Cl. G06F 30/20; G06F 111/06

(52) U.S. Cl. CPC G06F 30/20; G06F 2111/06

(57) ABSTRACT

The present invention discloses a rolling correction intelligent irrigation decision-making method for a regional wheat-corn rotation system, which belongs to the technical field of agricultural irrigation, and constructs a regional intelligent irrigation decision-making model with high water-use efficiency. In this model, irrigation data in a region no longer relies solely on annual average meteorological and soil data, but on real-time reading and processing of detailed meteorological elements and soil moisture information to dynamically optimize irrigation strategies according to daily changes. By means of daily optimization of the irrigation volumes in grids of the region, the spatial heterogeneity of a crop growth environment in a large-scale region can be reflected more finely, thereby improving the accuracy and reliability of a crop model in large-scale applications.

### CROSS-REFERENCE TO RELATED APPLICATION

This application claims the priority benefit to China application CN202510231728.3 filed on Feb. 28, 2025, the content of which is herein incorporated by reference in its entirety and made a part of this specification.

### TECHNICAL FIELD

The present invention belongs to the technical field of agricultural irrigation, and more particularly, relates to an intelligent irrigation decision-making method for a regional wheat-corn rotation system.

### BACKGROUND ART

At present, most of regional-scale optimization methods for wheat-corn irrigation programs are based on hydrological year division, and fail to fully consider the seasonal variations in water demand within a wheat-corn rotation system. The water demands of winter wheat and summer corn vary significantly during the growing season, and they have certain moisture complementarity, so reasonable allocation of water resources is the key to efficiently use agricultural water.

In the water management of the wheat-corn rotation system, there is a lack of research on a soil water allocation mechanism between two crop growing seasons, and the dynamic regulation of upper and lower limits of soil water is insufficient; and the improvement effects of straws returning to the field on water infiltration and irrigation demand are not fully quantified, and irrigation programs are insufficient in terms of regional real-time water supply conditions and adaptability to meteorological changes, which cannot well meet the growth needs of wheat and corn.

Precise and intelligent irrigation decision-making of the wheat-corn rotation system requires refined management and intelligent decision-making according to actual needs of wheat and corn growth, including sowing date, irrigation water volume, irrigation date and irrigation frequency. With the development of information technology and intelligent optimization algorithms, it is possible to use remote sensing, as well as meteorological and hydrological data for intelligent decision-making. At present, there is no dynamic optimization strategy based on real-time meteorological data and soil moisture changes to achieve a new balance between agricultural irrigation water and wheat/corn yield, so as to maximize economic benefits.

### SUMMARY OF THE INVENTION

The present invention aims to solve the technical problems in the background and to provide an intelligent irrigation decision-making method for a regional wheat-corn rotation system.

In order to solve the above technical problems, the technical solution of the present invention is as follows.

A rolling correction intelligent irrigation decision-making method for a regional wheat-corn rotation system includes:
S1: inputting acquired drive data into a crop growth model; performing sensitivity analysis on parameters of the crop growth model by using a Sobol method, screening non-sensitive parameters from the crop growth model and setting the non-sensitive parameters as default values; performing parameter calibration on sensitive parameters; inputting the calibrated sensitive parameters into a growth localization model, and coupling the growth localization model with a multi-objective optimization model;
performing model parameter calibration in combination with a particle swarm optimization (PSO) algorithm and the crop growth model, and with the goal of minimizing errors between measured values and simulated values of crop growth indicators, automatically calibrating the sensitive parameters in the crop growth model to obtain localized crop parameters and soil parameters of the crop growth model;
establishing a localized wheat-corn rotation system growth model;
S2: inputting crop model drive data in the planning year into the localized wheat-corn rotation system growth model to construct a distributed growth localization model of the regional wheat-corn rotation system in the planning year, and coupling the distributed growth localization model with a multi-objective optimization model; determining the impacts of water allocation and straws returning to the field on soil moisture and irrigation demand; based on the goals of maximizing the regional yield, minimizing the irrigation water volume and maximizing economic benefits, obtaining a high-resolution Pareto optimal solution of an irrigation program, and giving weights to long-term irrigation programs in different regions by using a TOPSIS method to obtain long-term irrigation programs for wheat-corn rotation systems in different regional spatial grids, thereby obtaining a regional spatial long-term irrigation decision-making optimization model;
S3: taking the long-term irrigation program as a reference, collecting in real time and inputting real-time read crop data, soil data, hydrological data, meteorological data, field management data and water supply data into the regional spatial long-term irrigation decision-making optimization model to determine the impacts of climate changes on the phenological period and optimize field management strategies; adjusting the irrigation program in real time, and determining whether to correct the reference irrigation program by taking a period biomass, water demand and available water supply as constraint conditions; by coupling the multi-objective optimization model, constructing a dynamic irrigation correction method to maximize the biomass, minimize a water demand decision-making error and maximize economic benefits, and adjusting the irrigation scheme in real time.

Further, prior to the step S1, the method further includes:
collection of drive data: collecting crop data, meteorological data, field management data and soil data of winter wheat and summer corn by using remotely-sensed field soil detectors and meteorological stations; and region division: dividing a decision-making region into a plurality of sub-regions according to a crop distribution map, soil types and water supply conditions for grid-based processing.

Further, a specific flow of the Sobol method and performing parameter calibration in combination with the PSO algorithm and the crop growth model in the step S1 include:
S101: determining input parameters and target variables of a model: determining input parameters and parameter ranges of a wheat-corn growth model, the input parameters including: crop parameters, soil parameters and meteorological parameters; determining target variables of the wheat-corn growth model, the target variables being a wheat/corn leaf area index and aboveground dry matter accumulation output in time series and a wheat/corn yield output in non-time series;
S102: sampling of input variables: ensuring that the variables are evenly distributed within their ranges by using a Latin hypercube sampling method, and generating a set of sample points for each input variable for model calculation;
S103: model evaluation: taking sample data generated by the Latin hypercube sampling method as output data, running the model to calculate an output result, repeating this process, and performing sensitivity analysis to ensure the quantity of samples and the accuracy of the analysis;
S104: calculation of variance decomposition: evaluating the impacts of input variables by means of variance decomposition by using the Sobol method, an output variance being expressed as a sum of variance contributions of the input variables:

$$Var ( Y ) = {\sum }_{i = 1}^{k} {V}_{i} + {\sum }_{1 \leq i \leq j} {V}_{ij} + … + {V}_{1 , 2 , … , k}$$

in which, Vᵢ represents a contribution of a single input variable to the output variance, Vᵢⱼ represents a contribution of an interaction effect of two input variables to the output variance, k is the quantity of input parameters, and Var(Y) is a total output variance of the model;
S105: calculation of Sobol sensitivity index: the Sobol index being a quantitative indicator used to measure the degree of contribution of each input parameter to the output of the model; calculating a first-order sensitivity index, a second-order sensitivity index and a global sensitivity index by means of programming software:
the first-order sensitivity index (Sᵢ) represents that the degree of contribution of a single input variable to the output variance is the degree to which the input variable affects the output result without considering other interaction effect, calculated by the following formula:

$${S}_{ij} = \frac{{V}_{ij}}{Var ( Y )}$$

in which, Sᵢ is the first-order sensitivity index, Vᵢ represents the contribution of a single input variable to the output variance, and Var(Y) is the total output variance of the model;
the second-order sensitivity index (Sᵢᵢ) represents that the degree of contribution of an interaction effect of two input variables to the output variance, calculated by the following formula:

$${ST}_{i} = \frac{Var ( Y ) - {V}_{- i}}{Var ( Y )}$$

Sᵢⱼ is the second-order sensitivity index, and Vᵢⱼ represents the contribution of the interaction effect of two input variables to the output variance;
the global sensitivity index (STᵢ) represents the degree of total contribution of an input variable to the output, including a first-order effect of the variable and an interaction effect with other input variables, calculated by the following formula:

$${ST}_{i} = \frac{Var ( Y ) - {V}_{- i}}{Var ( Y )}$$

STᵢ is the global sensitivity index, and Vᵢ represents the variances of all parameters except the i^{th} parameter;
S106: analysis and interpretation of results: according to the calculated sensitivity indexes, analyzing the degree of sensitivity of each parameter to the wheat/corn yield, leaf area index and aboveground dry matter accumulation, and performing parameter calibration on the input parameters with large sensitivity indexes; and
S107: parameter calibration of wheat-corn rotation system growth model: screening sensitive parameters of the model by using a Sobol analysis method, and performing parameter calibration in combination with PSO and the wheat-corn rotation system growth model.

Further, specific steps of PSO in the S107 step are as follows:
S1071: initialization: setting an initial particle swarm size, defining a maximum number of iterations of an algorithm, and setting initial values of a position and velocity of a particle, each particle representing a set of model parameter combinations, the position being a model parameter combination, and the velocity being a step size when the particle is updated;
S1072: evaluation of the fitness of each particle according to an objective function, that is, minimizing an error between a measured value and a simulated value of the crop growth indicator, the fitness value being used to measure the merit of the particle solution;
S1073: updating of the velocity and position: adjusting the velocity and position of the particle according to a historical optimal position of the particle and a global optimal position in the population by using an update formula of particle swarm optimization;
S1074: updating of local optimum and global optimum: after updating the velocity and position of each particle, recalculating its fitness value, and comparing the fitness value with an individual historical optimal position, updating the individual optimal position if the current fitness is better, and selecting the particle with the optimal fitness as the global optimum through the fitness evaluation of the entire population;
S1075: evaluation: performing fitness evaluation on the updated particle according to an objective function, calculating its performance in an optimization objective, the fitness evaluation being used to decide whether to update the individual optimal position and the global optimal position of the particle;
S1076: iterative updating: repeating steps S1073 to S1075 until the maximum number of iterations is met or the fitness value converges;
S1077: termination condition: terminating the algorithm when the maximum number of iterations is met or the fitness converges; and
S1078: output result: outputting an optimal solution set, that is, a set of optimal combinations of model parameters with the smallest errors between the simulated values and the measured values.

Further, the objective function in the process of establishing the localized wheat-corn rotation system growth model is as follows:

$$Obj = min ( \sqrt{\frac{{\sum }_{i = 1}^{n} {( {LAI}_{i}^{m} - {LAI}_{i}^{s} )}^{2}}{n}} + \sqrt{\frac{{\sum }_{i = 1}^{n} {( {TAGP}_{i}^{m} - {TAGP}_{i}^{s} )}^{2}}{n}} + \sqrt{\frac{{\sum }_{i = 1}^{m} {( {TWSO}_{i}^{m} - {TWSO}_{i}^{s} )}^{2}}{m}}$$

in which,

$${LAI}_{i}^{m} and {LAI}_{i}^{s}$$

are a measured value and a simulated value of the wheat/corn leaf area index, respectively;

$${TAGP}_{i}^{m} and {TAGP}_{i}^{s}$$

are a measured value and a simulated value of the overground dry matter accumulation of wheat/corn, respectively;

$${TWSO}_{i}^{m} and {TWSO}_{i}^{s}$$

are a measured value and a simulated value of the wheat/corn yield, respectively; n is the number of sampling times for the wheat/corn leaf area index and aboveground dry matter accumulation in measured sampling or in an experiment; and m is the number of sampling times for the wheat/corn yield.

Further, the step S2 includes:
S201: data input: inputting data required for the distributed growth localization model of the wheat-corn rotation system in the planning year into a crop model, the data including meteorological data, soil data, field management data and localization model parameters; constructing a distributed growth localization model of the wheat-corn rotation system under the adapted planning year; determining an objective function: determining optimization goals, that is, maximizing crop yield, minimizing irrigation water volume and maximizing economic effects;
S202: setting constraint conditions: with upper and lower limits of soil volume moisture content and regional water supply conditions as constraints, considering soil allocation characteristics and moisture complementarity in the wheat-corn rotation system: at the end of the winter wheat growing season, the soil moisture needs to be sufficiently reserved to meet the water demand in the event of entering the corn growing season, in order to ensure the limitation of available resources in actual production and ensure the normal growth of wheat and corn;
   a formula for a relationship between soil moisture contents of wheat and corn is as follows:

$${SM}_{corn} ( {t}_{0} ) = {SM}_{wheat} ( {t}_{1} ) + SM ( {t}_{2} , {t}_{3} )$$

in which, SM_{corn}(t₀) is the soil moisture content in the early stage of the corn growing period; SM_{wheat}(t₁) is the soil moisture content at the time of winter wheat harvest; ΔSM(t₂,t₃) is a variation quantity of soil moisture between the end of winter wheat growth and the beginning of corn growth, including the impacts of precipitation, evaporation and irrigation;
S203: water resource allocation and complementarity among crops: combined with seasonal characteristics of wheat-corn rotation, configuring water resource demands for winter wheat and summer corn in an optimization model according to soil moisture contents in growth periods of different crops;
S204: impacts of straws returning to the field on soil moisture infiltration and irrigation demand: in the distributed growth localization model of the wheat-corn rotation system, considering an improvement effect of straws returning to the field on the soil porosity and infiltration rate after the end of the corn growing season;
a formula for a relationship between summer corn straws returning to the field and the soil volume moisture content in the early stage of winter wheat is as follows:

$${SM}_{t} = {SM}_{0} + {SM}_{s} - {SM}_{e}$$

$${SM}_{s} = Δ SOM \times {S}_{water}$$

in which, SMₜ is the soil volume moisture content in the early stage of winter wheat; SM₀ is the initial soil volume moisture content of winter wheat; SMₛ is the variation quantity in soil volume moisture content caused by straws returning to the field; SMₑ is an evaporation amount of soil water; ΔSOM is an amount of straws returning to the field; S_{water} is an ability coefficient of soil organic matters to retain water;
S205: model coupling: coupling the distributed growth localization model of the wheat-corn rotation system with a multi-objective optimization model, transmitting crop input data as decision-making variables in the optimization model to the distributed growth localization model of the wheat-corn rotation system, and feeding back the yield, irrigation water volume and economic benefits after the operation of the distributed growth localization model of the wheat-corn rotation system to the optimization model;
S206: model solving: solving the optimization model by using an NSGA-II algorithm, and outputting a Pareto optimal solution set of an irrigation program under regional high-resolution grids; and
S207: preferential selection of TOPSIS comprehensive evaluation method: preferentially selecting a Pareto solution set, and further preferentially selecting the Pareto solution set by using the TOPSIS comprehensive evaluation method.

Further, the step S207 includes:
S2071: determining evaluation indicators: clarifying a decision-making objective and selecting relevant evaluation indicators, that is, the larger the crop yield value, the better; the smaller the irrigation water volume value, the better; the larger the economic benefit value, the better;
S2072: constructing a normalized decision-making matrix: organizing and normalizing original data, i.e., organizing crop yield, irrigation volume and economic benefit data in the Pareto solution set into a decision-making matrix Di×j, wherein i represents the number of Pareto solution sets, j represents the number of decision-making objectives, and each row of the matrix is an alternative; transforming the data into a unified scale by using a linear normalization method; determining weights of the evaluation indicators: according to the preferences of decision-makers, combining the evaluation indicators in different weights, which may be divided into a long-term irrigation program scheme for a wheat-corn rotation system in a region with high water-use efficiency and economic benefits, a long-term irrigation program scheme for a wheat-corn rotation system in a region with high yield and economic benefits, and a long-term irrigation program scheme for a wheat-corn rotation system in a region with water conservation and economic benefits;
S2073: calculating a positive and negative ideal solution: calculating a distance from each alternative to the positive and negative ideal solution; and
S2074: sorting: calculating a relative proximity according to the distance from each alternative to the positive and negative ideal solution, sorting the alternatives according to the relative proximity, and taking the alternative with the largest value as a long-term irrigation decision-making scheme for the wheat-corn rotation system in an optimal area under this preference perspective.

Further, the objective function of the regional spatial long-term irrigation decision-making optimization model is as follows:

$${Obj}_{1} = max TWSO$$

$${Obj}_{2} = min I$$

$${Obj}_{3} = max NEB$$

in which, TWSO is the wheat/corn yield per unit area; I is the irrigation water volume per unit area; NEB is the wheat/corn economic benefit per unit area;
the constraint conditions of the distributed growth localization model of the regional wheat-corn rotation system are as follows:
soil moisture content constraint:

$${SM}^{min} \leq SM \leq {SM}^{max}$$

in which, SM represents the soil moisture content in the root zone, and SM^{min} and SM^{max} represent a lower limit and an upper limit of the soil moisture content in the root zone, respectively;
irrigation water volume constraint:

$$I < R$$

in which, I is the irrigation water volume per unit area; R is available water volume per unit area; and
yield constraint:

$$\sum TWSO \cdot A = {TWSO}^{REG}$$

in which, TWSO^{REG} is a food demand in a region where an irrigation area is located.

Further, the step S3 includes:
S301: applying the regional long-term irrigation program to a study area as a reference long-term irrigation program, and setting the corresponding aboveground biomass under the reference long-term irrigation program as a reference aboveground biomass;
S302: acquiring remote sensing images of an irrigation decision-making region by means of a satellite platform or an unmanned aerial vehicle, and obtaining crop data of aboveground biomass and leaf area index by inversion of a regression model; acquiring real-time soil data by arranging a soil moisture monitor in the irrigation decision-making region; acquiring hydrological data from a long series of runoff monitoring data from a hydrological station; acquiring real-time meteorological data by building a small meteorological station in the irrigation decision-making region; acquiring field management data through real-time input of agricultural management measures by field managers, the agricultural management measures including single irrigation volume, irrigation date, fertilization amount, and fertilization date;
S303: at the end of winter wheat harvest or summer corn harvest, exploring the impacts of real-time meteorological condition changes on the phenological periods of wheat and corn by reading the drive data in real time, inputting future meteorological data into the distributed growth localization model of the regional wheat-corn rotation system, and with the goal of maximizing the yield, exploring the optimal sowing date of summer corn or winter wheat;
S304: inputting the real-time drive data into the distributed growth localization model of the regional wheat-corn rotation system; determining whether to correct the reference irrigation program through constraint conditions; redeciding the irrigation program for a grid point that does not meet any of the three constraints; following the reference irrigation program for grid points that meet the constraint conditions; the specific constraint conditions are as follows:
a period biomass constraint:

$$K \cdot Bio \geq {Bio}^{R}$$

in which, K is a correction factor; Bio is a period biomass; Bio^{R} is a period biomass under the reference irrigation system;
a water supply constraint:

$${Q}^{S} \geq {Q}^{D}$$

in which, Q^{S} is the water supply; Q^{D} is the water demand;
a water demand decision-making error constraint:

$$\frac{\vert {I}^{R} + P - ET \vert}{ET} \leq 8 \%$$

in which, I^{R} is a total irrigation volume in the current period, P is a rainfall in the current period; ET is a water demand in the current period; and
S305: redeciding the irrigation program for the next 15 days for a grid that needs to be updated for the irrigation program, solving the model by using a particle swarm algorithm in order to ensure the operating efficiency of the model, and constructing an adaptive correction decision-making model with the goals of maximizing the period biomass and minimizing the water demand decision-making error.

Compared with the prior art, the present invention has the following advantages. In the present invention, the regional intelligent irrigation decision-making model with high water-use efficiency is constructed. In this model, irrigation data in a region no longer relies solely on the annual average meteorological and soil data, but on real-time reading and processing of detailed meteorological elements and soil moisture information to dynamically optimize irrigation strategies according to daily changes. By means of daily optimization of the irrigation volumes in grids of the region, the spatial heterogeneity of a crop growth environment in a large-scale region can be reflected more finely, thereby improving the accuracy and reliability of a crop model in large-scale applications.

### BRIEF DESCRIPTION OF THE DRAWINGS

FIG. 1 is a technical flowchart of a rolling correction intelligent irrigation decision-making method for a regional wheat-corn rotation system.

### DETAILED DESCRIPTION OF THE INVENTION

The specific implementation of the present invention is described below in conjunction with the embodiments.

It should be noted that the structure, ratio, size, etc. shown in the present description are only used to match the content disclosed in the description for those skilled in the art to understand and read, and are not regarded as limiting conditions for the implementation of the present invention. Any structural modification, proportional relationship change or size adjustment should still fall within the scope of the technical content disclosed in the present invention, without affecting the effects and objectives that can be achieved by the present invention.

Meanwhile, the terms such as “upper”, “lower”, “left”, “right”, “middle” and “one” cited in the present description are only for the convenience of description and are not used to limit the scope of implementation of the present invention, and any changes or adjustments of their relative relationships shall also be regarded as the applicable scope of the present invention without any substantial change in the technical content.

### Embodiment 1

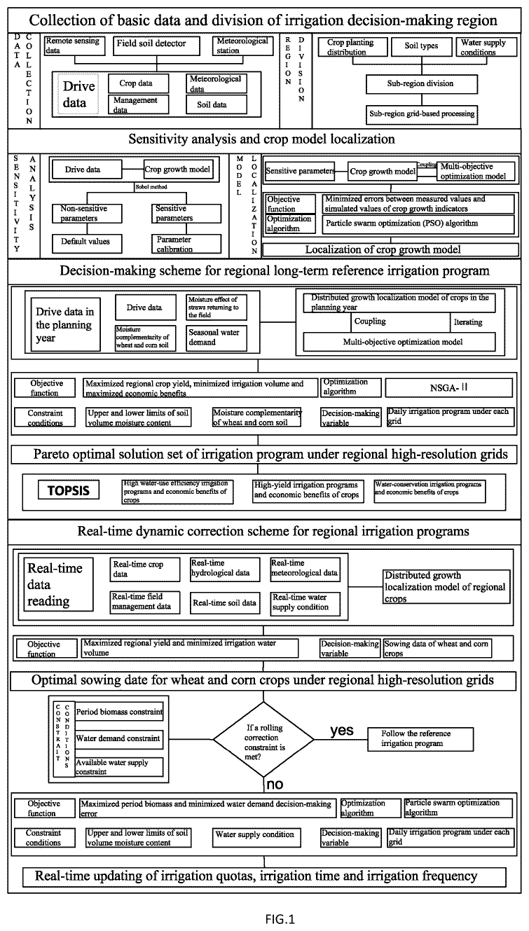

As shown in FIG. 1, the present invention provides a rolling correction intelligent irrigation decision-making method for a regional wheat-corn rotation system. The method includes the following steps.

### S1: Collection of Basic Data and Division of Irrigation Decision-Making Region

Collecting crop data, meteorological data, field management data and soil data of winter wheat and summer corn by using remotely-sensed field soil detectors and meteorological stations; and dividing a decision-making region into four sub-regions according to a regional winter wheat-summer corn planting distribution map, soil types and regional water supply conditions; performing grid-based processing on the sub-regions.

### S2: Sensitivity Analysis and Crop Model Localization

Inputting model drive data into a crop growth model; performing sensitivity analysis on parameters of the crop growth model by using a Sobol method, screening non-sensitive parameters from the crop growth model and setting the non-sensitive parameters as default values; and performing parameter calibration on sensitive parameters.
A flow of the Sobol method is as follows:
1. determination of input parameters and target variables of a model:
determining input parameters and parameter ranges of a wheat-corn growth model, the input parameters including: crop parameters, soil parameters and meteorological parameters; determining target variables of the wheat-corn growth model, the target variables being a wheat/corn leaf area index and aboveground dry matter accumulation output in time series and a wheat/corn yield output in non-time series;
2. sampling of input variables:
ensuring that the variables are evenly distributed within their ranges by using a Latin hypercube sampling method, wherein a set of sample points needs to be generated for each input variable, these sample points being used for model calculation;
3. model evaluation:
taking sample data generated by the Latin hypercube sampling method as output data, running the model to calculate an output result, repeating this process till enough sample points for outputting samples are obtained, and performing sensitivity analysis to ensure large enough (several thousand) samples and the accuracy of the analysis;
4. calculation of variance decomposition:
evaluating the impacts of input variables by means of variance decomposition by using a Sobol method; specifically, an output variance may be expressed as a sum of variance contributions of the input variables:

$$Var ( Y ) = {\sum }_{i = 1}^{k} {V}_{i} + {\sum }_{1 \leq i \leq j} {V}_{ij} + … + {V}_{1 , 2 , ... , k} ;$$

in which, Vᵢ represents a contribution of a single input variable to the output variance, Vᵢⱼ represents a contribution of an interaction effect of two input variables to the output variance, k is the quantity of input parameters, and Var(Y) is a total output variance of the model;
5. calculation of Sobol sensitivity index:
the Sobol index being a quantitative indicator used to measure the degree of contribution of each input parameter to the output of the model; calculating a first-order sensitivity index, a second-order sensitivity index and a global sensitivity index by means of programming software:
   the first-order sensitivity index (Sᵢ) represents that the degree of contribution of a single input variable to the output variance. It may be understood that the degree of contribution of a single input variable to the output variance is the degree to which the input variable affects the output result without considering other interaction effect. A calculation formula of the first-order sensitivity index is as follows:

$${S}_{i} = \frac{{V}_{i}}{Var ( Y )}$$

in which, Sᵢ is the first-order sensitivity index, Vᵢ represents the contribution of a single input variable to the output variance, and Var(Y) is the total output variance of the model;
the second-order sensitivity index (Sᵢᵢ) represents that the degree of contribution of an interaction effect of two input variables to the output variance. A calculation formula of the second-order sensitivity index is as follows:

$${S}_{ij} = \frac{{V}_{ij}}{Var ( Y )}$$

Sᵢⱼ is the second-order sensitivity index, and Vᵢⱼ represents the contribution of the interaction effect of two input variables to the output variance; and
the global sensitivity index (STᵢ) represents the degree of total contribution of an input variable to the output, including a first-order effect of the variable and an interaction effect with other input variables. A calculation formula of the global sensitivity index is as follows:

$${ST}_{i} = \frac{Var ( Y ) - {V}_{- i}}{Var ( Y )}$$

in which, STᵢ is the global sensitivity index, and Vᵢ represents the variances of all parameters except the i^{th} parameter;
6. Analysis and interpretation of results:
according to the calculated sensitivity indexes, analyzing the degree of sensitivity of each parameter to the wheat/corn yield, leaf area index and aboveground dry matter accumulation, and performing parameter calibration on the input parameters with large sensitivity indexes; and
determining a sensitivity score in each sub-region that needs to be calibrated, performing model parameter calibration in combination with a particle swarm optimization (PSO) algorithm and the crop growth model, and with the goal of minimizing errors between measured values and simulated values of crop growth indicators, automatically calibrating the sensitive parameters in the crop growth model to obtain localized crop parameters and soil parameters of the crop growth model; and establishing a localized wheat-corn rotation system growth model.

Specific steps of PSO are as follows:
1. initialization: setting an initial particle swarm size, defining a maximum number of iterations of an algorithm, and setting initial values of a position and velocity of a particle; each particle representing a set of model parameter combinations, the position being a model parameter combination, and the velocity being a step size when the particle is updated;
2. evaluation of the fitness of each particle according to an objective function, that is, minimizing an error between a measured value and a simulated value of the crop growth indicator, the fitness value being used to measure the merit of the particle solution;
3. updating of the velocity and position: adjusting the velocity and position of the particle according to a historical optimal (individual optimal) position of the particle and a global optimal position in the population by using an update formula of particle swarm optimization;
4. updating of local optimum and global optimum: after updating the velocity and position of each particle, recalculating its fitness value, and comparing the fitness value with an individual historical optimal position, updating the individual optimal position if the current fitness is better, and selecting the particle with the optimal fitness as the global optimal through the fitness evaluation of the entire population;
5. evaluation: performing fitness evaluation on the updated particle according to an objective function, and calculating its performance in an optimization objective, the fitness evaluation being used to decide whether to update the individual optimal position and the global optimal position of the particle;
6. iterative updating: repeating steps 3 to 5 until the maximum number of iterations is met or the fitness value converges;
7. termination condition: terminating the algorithm when the maximum number of iterations is met or the fitness converges; and
8. output result: outputting an optimal solution set, that is, a set of optimal combinations of model parameters with the smallest errors between the simulated values and the measured values.

According to this embodiment, the objective function of the localized optimization model of the wheat-corn rotation system growth model in step S27 is as follows:

$$Obj = min ( \sqrt{\frac{{\sum }_{i = 1}^{n} {( {LAI}_{i}^{m} - {LAI}_{i}^{s} )}^{2}}{n}} + \sqrt{\frac{{\sum }_{i = 1}^{n} {( {TAGP}_{i}^{m} - {TAGP}_{i}^{s} )}^{2}}{n}} + \sqrt{\frac{{\sum }_{i = 1}^{m} {( {TWSO}_{i}^{m} - {TWSO}_{i}^{s} )}^{2}}{m}}$$

in which,

$${LAI}_{i}^{m} and {LAI}_{i}^{s}$$

are a measured value and a simulated value of the wheat/corn leaf area index, respectively;

$${TAGP}_{i}^{m} and {TAGP}_{i}^{s}$$

are a measured value and a simulated value of the overground dry matter accumulation of wheat/corn, respectively;

$${TWSO}_{i}^{m} and {TWSO}_{i}^{s}$$

are a measured value and a simulated value of the wheat/corn yield, respectively; n is the number of sampling times for the wheat/corn leaf area index and aboveground dry matter accumulation in measured sampling or in an experiment; and m is the number of sampling times for the wheat/corn yield.

### S3: Decision-Making Scheme for Regional Long-Term Reference Irrigation System

Inputting crop model drive data (crop data, field management data, meteorological data, and soil data) in the planning year into the localized wheat-corn rotation system growth model to construct a distributed growth localization model of the regional wheat-corn rotation system in the planning year; coupling the distributed growth localization model of the wheat-corn rotation system with a multi-objective optimization model; clarifying a relationship between soil water allocation and complementarity of the wheat-corn rotation system; clarifying a regulating effect of straws returning to the field in the wheat-corn rotation system on soil water infiltration and irrigation demand; constructing a regional grid-refined dynamic irrigation decision-making technology; with the goals of maximizing the regional wheat/corn yield, minimizing the irrigation water volume and maximizing wheat/corn economic benefits, by taking upper and lower limits of the soil volume moisture content and water supply conditions as constraint conditions, obtaining a Pareto optimal solution of an irrigation program of the wheat/corn rotation system under high resolution, and giving weights to a plurality of objectives by using a TOPSIS comprehensive evaluation method to obtain long-term irrigation programs for wheat-corn rotation systems in different regional spatial grids.

The formulation of the regional spatial long-term irrigation decision-making scheme requires the coupling of the distributed growth localization model of the wheat-corn rotation system with the multi-objective optimization model, and the specific steps are as follows:
1. data input: inputting data required for the distributed growth localization model of the wheat-corn rotation system in the planning year into the crop model, the data including meteorological data, soil data, field management data and localization model parameters; constructing a distributed growth localization model of the wheat-corn rotation system under the adapted planning year; determining an objective function: determining optimization goals, that is, maximizing crop yield, minimizing irrigation water volume and maximizing economic effects;
2. setting constraint conditions: with upper and lower limits of soil volume moisture content and regional water supply conditions as constraints, considering soil allocation characteristics and moisture complementarity in the wheat-corn rotation system: at the end of the winter wheat growing season, the soil moisture needs to be sufficiently reserved to meet the water demand in the event of entering the corn growing season, in order to ensure the limitation of available resources in actual production and ensure the normal growth of wheat and corn;
a formula for a relationship between soil moisture contents of wheat and corn is as follows:

$${SM}_{corn} ( {t}_{0} ) = {SM}_{wheat} ( {t}_{1} ) + SM ( {t}_{2} , {t}_{3} )$$

in which, SM_{corn}(t₀) is the soil moisture content in the early stage of the corn growing period; SM_{wheat}(t₁) is the soil moisture content at the time of winter wheat harvest; ΔSM(t₂,t₃) is a variation quantity (including the impacts of precipitation, evaporation and irrigation) of soil moisture between the end of winter wheat growth and the beginning of corn growth;
3. water resource allocation and complementarity among crops: combined with seasonal characteristics of wheat-corn rotation, configuring water resource demands for winter wheat and summer corn in an optimization model according to soil moisture contents in growth periods of different crops;
4. impacts of straws returning to the field on soil moisture infiltration and irrigation demand: in the distributed growth localization model of the wheat-corn rotation system, considering an improvement effect of straws returning to the field on the soil porosity and infiltration rate after the end of the corn growing season;
a formula for a relationship between summer corn straws returning to the field and the soil volume moisture content in the early stage of winter wheat is as follows:

$${SM}_{t} = {SM}_{0} + {SM}_{s} - {SM}_{e}$$

$${SM}_{s} = Δ SOM \times {S}_{water}$$

in which, SMₜ is the soil volume moisture content in the early stage of winter wheat; SM₀ is the initial soil volume moisture content of winter wheat; SMₛ is the variation quantity in soil volume moisture content caused by straws returning to the field; SMₑ is an evaporation amount of soil water; ΔSOM is an amount of straws returning to the field; S_{water} is an ability coefficient of soil organic matters to retain water;
5. model coupling: coupling the distributed growth localization model of the wheat-corn rotation system with a multi-objective optimization model, transmitting crop input data as decision-making variables in the optimization model to the distributed growth localization model of the wheat-corn rotation system, and feeding back the yield, irrigation water volume and economic benefits after the operation of the distributed growth localization model of the wheat-corn rotation system to the optimization model; and
6. model solving: solving the optimization model by using an NSGA-II algorithm, and outputting a Pareto optimal solution set of an irrigation program under regional high-resolution grids.

Further, specific steps of NSGA-II are as follows:
initialization: setting an initial population size, defining the maximum number of iterations of an algorithm, setting a crossover probability and a mutation probability, and randomly generating an initial population, each individual being a set of grid-based irrigation program combinations;
evaluation: according to an objective function, evaluating the fitness of each individual, that is, maximizing regional crop yield, minimizing irrigation water volume and maximizing economic benefits;
selection: grading individuals by non-dominance sorting and calculating crowding distances to maintain the diversity, and preferentially selecting individuals with low non-dominance grades and large crowding distances;
crossover: performing a crossover operation on the selected parent individuals to generate new individuals, in the crossover operation, a crossover probability being used to determine whether to perform crossover, and the new individuals being generated by combining genetic information of two parent individuals;
mutation: performing a mutation operation on the crossed individuals to increase the population diversity and avoid falling into local optimum, in the mutation operation, a mutation probability being used to determine whether to perform mutation, and new individuals being generated by randomly changing individual genetic information;
evaluation: performing fitness evaluation on the newly generated individuals according to an objective function, and calculating their performances in an optimization objective for sorting and screening;
replacement: selecting parents and offspring through non-dominant sorting and crowding distances, and optimizing and reserving high-quality individuals to generate the next generation population;
termination condition: terminating the algorithm when the maximum number of iterations is met or the fitness converges;
output result: outputting an optimal solution set, that is, a set of grid-based irrigation programs with maximized regional crop yield, minimized irrigation water volume and maximized economic benefits; and
preferential selection of TOPSIS comprehensive evaluation method: preferentially selecting a Pareto solution set, and further preferentially selecting the Pareto solution set by using the TOPSIS comprehensive evaluation method.

Specific steps of the TOPSIS comprehensive evaluation method are as follows:
1. determining evaluation indicators: clarifying a decision-making objective and selecting relevant evaluation indicators, that is, the larger the crop yield value, the better; the smaller the irrigation water volume value, the better; the larger the economic benefit value, the better;
2. constructing a normalized decision-making matrix: organizing and normalizing original data, i.e., organizing crop yield, irrigation water volume and economic benefit data in the Pareto solution set into a decision-making matrix Di×j, wherein i represents the number of Pareto solution sets, j represents the number of decision-making objectives, and each row of the matrix is an alternative; transforming the data into a unified scale by using a linear normalization method; determining weights of the evaluation indicators: according to the preferences of decision-makers, combining the evaluation indicators in different weights, which may be divided into a long-term irrigation program scheme for a wheat-corn rotation system in a region with high water-use efficiency and economic benefits, a long-term irrigation program scheme for a wheat-corn rotation system in a region with high yield and economic benefits, and a long-term irrigation program scheme for a wheat-corn rotation system in a region with water conservation and economic benefits;
3. calculating a positive and negative ideal solution: calculating a distance from each alternative to the positive and negative ideal solution; and
4. sorting: calculating a relative proximity according to the distance from each alternative to the positive and negative ideal solution, sorting the alternatives according to the relative proximity, and taking the alternative with the largest value as a long-term irrigation decision-making scheme for the wheat-corn rotation system in an optimal area under this preference perspective.

According to some embodiments, the objective function of the regional spatial long-term irrigation decision-making optimization model is as follows:

$${Obj}_{1} = max TWSO$$

$${Obj}_{2} = min I$$

$${Obj}_{3} = max NEB$$

in which, TWSO is the wheat/corn yield per unit area; I is the irrigation water volume per unit area; NEB is the wheat/corn economic benefit per unit area.

The constraint conditions of the distributed growth localization model of the regional wheat-corn rotation system are as follows:
a soil moisture content constraint:

$${SM}^{min} \leq SM \leq {SM}^{max}$$

in which, SM represents the soil moisture content in the root zone, and SM^{min} and SM^{max} represent a lower limit and an upper limit of the soil moisture content in the root zone, respectively;
an irrigation water volume constraint:

$$I < R$$

in which, I is the irrigation water volume per unit area; R is available water volume per unit area; and
a yield constraint:

$$\sum TWSO \cdot A = {TWSO}^{reg}$$

in which, TWSO^{REG} is a food demand in a region where an irrigation area is located.

### S4: Real-Time Dynamic Correction Scheme for Regional Irrigation Programs

Taking the long-term irrigation program of the regional spatial grid-based wheat-corn rotation system as a reference, and applying this program to a decision-making region; inputting real-time read crop data, soil data, hydrological data, meteorological data, field management data and water supply data into the distributed growth localization model of the region wheat-corn rotation system to explore the impacts of climate changes on the phenological period of the wheat-corn rotation system and optimize field management strategies; adjusting the irrigation program in real time, and determining whether to correct the reference irrigation program by taking the period biomass, water demand and available water supply as constraint conditions; coupling the distributed growth localization model of the wheat-corn rotation system with a multi-objective optimization model, and constructing a regional grid-refined dynamic irrigation correction technology; and with the goals of maximizing the period biomass, minimizing a water demand decision-making error and maximizing economic benefits, by taking the soil volume moisture content and water supply conditions as constraint conditions, correcting the reference irrigation program in real time.

Specific steps of the real-time dynamic correction scheme for regional irrigation programs are as follows:
1. applying the regional long-term irrigation program to a study area as a reference long-term irrigation program, and setting the corresponding aboveground biomass under the reference long-term irrigation program as a reference aboveground biomass;
2. acquiring remote sensing images of an irrigation decision-making region by means of a satellite platform or an unmanned aerial vehicle, and obtaining crop data of aboveground biomass and leaf area index by inversion of a regression model; acquiring real-time soil data by arranging a soil moisture monitor in the irrigation decision-making region; acquiring hydrological data from a long series of runoff monitoring data from a hydrological station; acquiring real-time meteorological data by building a small meteorological station in the irrigation decision-making region; acquiring field management data through real-time input of agricultural management measures by field managers, the agricultural management measures including, but not limited to single irrigation volume, irrigation date, fertilization amount, and fertilization date;
3. at the end of winter wheat harvest or summer corn harvest, exploring the impacts of real-time meteorological condition changes on the phenological periods of wheat and corn by reading the drive data in real time, and inputting future meteorological data into the distributed growth localization model of the regional wheat-corn rotation system, and with the goal of maximizing the yield, exploring the optimal sowing date of summer corn or winter wheat;
4. inputting the real-time drive data into the distributed growth localization model of the regional wheat-corn rotation system; determining whether to correct the reference irrigation program through constraint conditions; redeciding the irrigation program for a grid point that does not meet any of the three constraints; and following the reference irrigation program for grid points that meet the constraint conditions, wherein the specific constraint conditions are as follows:
a period biomass constraint:

$$K \cdot Bio \geq {Bio}^{R}$$

in which, K is a correction factor; Bio is a period biomass; Bio^{R} is a period biomass under the reference irrigation program;
a water supply constraint:

$${Q}^{S} \geq {Q}^{D}$$

in which, Q^{S} is the water supply; Q^{D} is the water demand;
a water demand decision-making error constraint:

$$\frac{\vert {I}^{R} + P - ET \vert}{ET} \leq 8 \%$$

in which, I^{R} is a total irrigation volume in the current period, P is a rainfall in the current period; ET is a water demand in the current period; and
5. redeciding the irrigation program for the next 15 days for a grid that needs to be updated for the irrigation program, solving the model by using a particle swarm algorithm in order to ensure the operating efficiency of the model, and constructing an adaptive correction decision-making model with the goals of maximizing the period biomass and minimizing the water demand decision-making error.

The preferred embodiments of the present invention are described in detail above in conjunction with the accompanying drawings. However, the present invention is not limited to the above-mentioned embodiments, and various changes can be made without departing from the purpose of the present invention within the scope of knowledge possessed by those of ordinary skill in the art.

Many other changes and modifications can be made without departing from the conception and scope of the present invention. It should be understood that the present invention is not limited to specific embodiments, and the scope of the present invention is limited by the attached claims.

1. A rolling correction intelligent irrigation decision-making method for a regional wheat-corn rotation system, comprising:
S1: inputting acquired drive data into a crop growth model; performing sensitivity analysis on parameters of the crop growth model by using a Sobol method, screening non-sensitive parameters from the crop growth model and setting the non-sensitive parameters as default values; performing parameter calibration on sensitive parameters; performing model parameter calibration in combination with a particle swarm optimization (PSO) algorithm and the crop growth model, and with the goal of minimizing errors between measured values and simulated values of crop growth indicators, automatically calibrating the sensitive parameters in the crop growth model to obtain localized crop parameters and soil parameters of the crop growth model; establishing a localized wheat-corn rotation system growth model;
S2: inputting crop model drive data in the planning year into the localized wheat-corn rotation system growth model to construct a distributed growth localization model of the regional wheat-corn rotation system in the planning year, and coupling the distributed growth localization model with a multi-objective optimization model; determining the impacts of water allocation and straws returning to the field on soil moisture and irrigation demand, thereby obtaining a regional spatial long-term irrigation decision-making optimization model; based on the goals of maximizing the regional yield, minimizing the irrigation volume and maximizing economic benefits, obtaining a high-resolution Pareto optimal solution of an irrigation program, and giving weights to long-term irrigation programs in different regions by using a TOPSIS method to obtain long-term irrigation programs for wheat-corn rotation systems in different regional spatial grids; step S2 comprising:
setting constraint conditions: with upper and lower limits of soil volume moisture content and regional water supply conditions as constraints, considering soil allocation characteristics and moisture complementarity in the wheat-corn rotation system: at the end of the winter wheat growing season, the soil moisture needs to be sufficiently reserved to meet the water demand in the event of entering the corn growing season, in order to ensure the limitation of available resources in actual production and ensure the normal growth of wheat and corn;
a formula for a relationship between soil moisture contents of wheat and corn is as follows:
$${SM}_{corn} ( {t}_{0} ) = {SM}_{wheat} ( {t}_{1} ) + Δ SM ( {t}_{2} , {t}_{3} ) ;$$
in which, SM_{corn} (t₀) is the soil moisture content in the early stage of the corn growing period; SM_{wheat} (t₁) is the soil moisture content at the time of winter wheat harvest; ΔSM (t₂, t₃) is a variation quantity of soil moisture between the end of winter wheat growth and the beginning of corn growth, comprising the impacts of precipitation, evaporation and irrigation;
water resource allocation and complementarity among crops: combined with seasonal characteristics of wheat-corn rotation, configuring water resource demands for winter wheat and summer corn according to soil moisture contents in growth periods of different crops;
impacts of straws returning to the field on soil moisture infiltration and irrigation demand: in the distributed growth localization model of the wheat-corn rotation system, considering an improvement effect of straws returning to the field on the soil porosity and infiltration rate after the end of the corn growing season;
a formula for a relationship between summer corn straws returning to the field and the soil volume moisture content in the early stage of winter wheat is as follows:
$${SM}_{t} = {SM}_{0} + {SM}_{s} - {SM}_{e} ;$$
$${SM}_{S} = Δ SOM \times {S}_{water} ;$$
in which, SMₜ is the soil volume moisture content in the early stage of winter wheat; SM₀ is the initial soil volume moisture content of winter wheat; SMₛ is the variation quantity in soil volume moisture content caused by straws returning to the field; SMₑ is an evaporation amount of soil water; ΔSOM is an amount of straws returning to the field; S_{water} is an ability coefficient of soil organic matters to retain water;
model coupling: coupling the distributed growth localization model of the wheat-corn rotation system with a multi-objective optimization model, transmitting crop input data as decision-making variables in the optimization model to the distributed growth localization model of the wheat-corn rotation system, and feeding back the yield, irrigation water volume and economic benefits after the operation of the distributed growth localization model of the wheat-corn rotation system to the optimization model; and
S3: taking a long-term irrigation program as a reference, collecting in real time and inputting real-time read crop data, soil data, hydrological data, meteorological data, field management data and water supply data into a regional spatial long-term irrigation decision-making optimization model to determine the impacts of climate changes on the phenological period and optimize field management strategies; adjusting the irrigation program in real time, and determining whether to correct the reference irrigation program by taking a period biomass, water demand and available water supply as constraint conditions; by coupling the multi-objective optimization model, constructing a dynamic irrigation correction method to maximize the biomass, minimize a water demand decision-making error and maximize economic benefits, and adjusting the irrigation scheme in real time; step S3 comprising: at the end of winter wheat harvest or summer corn harvest, exploring the impacts of changes of real-time meteorological conditions on the phenological periods of wheat and corn by reading the drive data in real time, and inputting future meteorological data into the distributed growth localization model of the regional wheat-corn rotation system to explore an optimal sowing date of summer corn or winter wheat.

2. The rolling correction intelligent irrigation decision-making method for a regional wheat-corn rotation system according to claim 1, wherein prior to the step S1, the method further comprises:
collection of drive data: collecting crop data, meteorological data, field management data and soil data of winter wheat and summer corn by using remotely-sensed field soil detectors and meteorological stations; and region division: dividing a decision-making region into a plurality of sub-regions according to a crop distribution map, soil types and water supply conditions for grid-based processing.

3. The rolling correction intelligent irrigation decision-making method for a regional wheat-corn rotation system according to claim 1, wherein a specific flow of the Sobol method and performing parameter calibration in combination with the PSO algorithm and the crop growth model in the step S1 comprise:
S101: determining input parameters and target variables of a model: determining input parameters and parameter ranges of a wheat-corn growth model, the input parameters comprising: crop parameters, soil parameters and meteorological parameters; determining target variables of the wheat-corn growth model, the target variables being a wheat/corn leaf area index and aboveground dry matter accumulation output in time series and a wheat/corn yield output in non-time series;
S102: sampling of input variables: ensuring that the variables are evenly distributed within their ranges by using a Latin hypercube sampling method, and generating a set of sample points for each input variable for model calculation;
S103: model evaluation: taking sample data generated by the Latin hypercube sampling method as output data, running the model to calculate an output result, repeating this process, and performing sensitivity analysis to ensure the quantity of samples and the accuracy of the analysis;
S104: calculation of variance decomposition: evaluating the impacts of input variables by means of variance decomposition, an output variance being expressed as a sum of variance contributions of the input variables:
$$Var ( Y ) = {\sum }_{i = 1}^{k} {V}_{i} + {\sum }_{1 \leq i \leq j} {V}_{ij} + ⋯ + {V}_{1 , 2 , … , k} ;$$
in which, Vᵢ represents a contribution of a single input variable to the output variance, Vᵢⱼ represents a contribution of an interaction effect of two input variables to the output variance, k is the quantity of input parameters, and Var(Y) is a total output variance of the model;
S105: calculation of Sobol sensitivity index: the Sobol index being a quantitative indicator used to measure the degree of contribution of each input parameter to the output of the model; calculating a first-order sensitivity index, a second-order sensitivity index and a global sensitivity index by means of programming software:
the first-order sensitivity index (Sᵢ) represents that the degree of contribution of a single input variable to the output variance is the degree to which the input variable affects the output result without considering other interaction effect, calculated by the following formula:
$${S}_{i} = \frac{{V}_{i}}{Var ( Y )} ;$$
in which, Sᵢ is the first-order sensitivity index, Vᵢ represents the contribution of a single input variable to the output variance, and Var(Y) is the total output variance of the model;
the second-order sensitivity index (Sᵢᵢ) represents that the degree of contribution of an interaction effect of two input variables to the output variance, calculated by the following formula:
$${S}_{ij} = \frac{{V}_{ij}}{Var ( Y )} ;$$
Sᵢⱼ is the second-order sensitivity index, and Vᵢⱼ represents the contribution of the interaction effect of two input variables to the output variance;
the global sensitivity index (STᵢ) represents the degree of total contribution of an input variable to the output, comprising a first-order effect of the variable and an interaction effect with other input variables, calculated by the following formula:
$$S {T}_{i} = \frac{Var ( Y ) - {V}_{- i}}{Var ( Y )} ;$$
STᵢ is the global sensitivity index, and Vᵢ represents the variances of all parameters except the i^{th} parameter;
S106: analysis and interpretation of results: according to the calculated sensitivity indexes, analyzing the degree of sensitivity of each parameter to the wheat/corn yield, wheat/corn leaf area index and aboveground dry matter accumulation, and performing parameter calibration on the input parameters with large sensitivity indexes; and
S107: parameter calibration of wheat-corn rotation system growth model: screening sensitive parameters of the model by using a Sobol analysis method, and performing parameter calibration in combination with PSO and the wheat-corn rotation system growth model.

4. The rolling correction intelligent irrigation decision-making method for a regional wheat-corn rotation system according to claim 3, wherein specific steps of PSO in the S107 step are as follows:
S1071: initialization: setting an initial particle swarm size, defining a maximum number of iterations of an algorithm, and setting initial values of a position and velocity of a particle, each particle representing a set of model parameter combinations, the position being a model parameter combination, and the velocity being a step size when the particle is updated;
S1072: evaluation of the fitness of each particle according to an objective function, that is, minimizing an error between a measured value and a simulated value of the crop growth indicator, the fitness value being used to measure the merit of the particle solution;
S1073: updating of the velocity and position: adjusting the velocity and position of the particle according to a historical optimal position of the particle and a global optimal position in the population by using an update formula of particle swarm optimization;
S1074: updating of local optimum and global optimum: after updating the velocity and position of each particle, recalculating its fitness value, and comparing the fitness value with an individual historical optimal position, updating an individual optimal position if the current fitness is better, and selecting the particle with the optimal fitness as the global optimum through the fitness evaluation of the entire population;
S1075: evaluation: performing fitness evaluation on the updated particle according to an objective function, calculating its performance in an optimization objective, the fitness evaluation being used to decide whether to update the individual optimal position and the global optimal position of the particle;
S1076: iterative updating: repeating steps S1073 to S1075 until the maximum number of iterations is met or the fitness value converges;
S1077: termination condition: terminating the algorithm when the maximum number of iterations is met or the fitness converges; and
S1078: output result: outputting an optimal solution set, that is, a set of optimal combinations of model parameters with the smallest errors between the simulated values and the measured values.

5. The rolling correction intelligent irrigation decision-making method for a regional wheat-corn rotation system according to claim 1, wherein the objective function in the process of establishing the localized wheat-corn rotation system growth model is as follows:
$$Obj = min ( \sqrt{\frac{{\sum }_{i = 1}^{n} {( {LAI}_{i}^{m} - {LAI}_{i}^{s} )}^{2}}{n}} + \sqrt{\frac{{\sum }_{i = 1}^{n} {( {TAGP}_{i}^{m} - {TAGP}_{i}^{s} )}^{2}}{n}} + \sqrt{\frac{{\sum }_{i = 1}^{m} {( {TWSO}_{i}^{m} - {TWSO}_{i}^{s} )}^{2}}{m}} )$$
in which,
$${LAI}_{i}^{m} and {LAI}_{i}^{s}$$
are a measured value and a simulated value of the wheat/corn leaf area index, respectively;
$${TAGP}_{i}^{m}$$
and TAGPᵢ^{s} are a measured value and a simulated value of the overground dry matter accumulation of wheat/corn, respectively;
$${TWSO}_{i}^{m} and {TWSO}_{i}^{s}$$
are a measured value and a simulated value of the wheat/corn yield, respectively; n is the number of sampling times for the wheat/corn leaf area index and aboveground dry matter accumulation in measured sampling or in an experiment; and m is the number of sampling times for the wheat/corn yield.

6. The rolling correction intelligent irrigation decision-making method for a regional wheat-corn rotation system according to claim 1, wherein the objective function of the regional spatial long-term irrigation decision-making optimization model is as follows:
$${Obj}_{1} = max TWSO ;$$
$${O bj}_{2} = min I ;$$
$${O bj}_{3} = max NEB ;$$
in which, TWSO is the wheat/corn yield per unit area; I is the irrigation water volume per unit area; NEB is the economic benefits of wheat/corn per unit area;
the constraint conditions of the distributed growth localization model of the regional wheat-corn rotation system are as follows:
soil moisture content constraint:
$$S {M}^{m i n} \leq S M \leq S {M}^{ma x} ;$$
in which, SM represents the soil moisture content in the root zone, and SM^{min} and SM^{max} represent a lower limit and an upper limit of the soil moisture content in the root zone, respectively;
irrigation water volume constraint:
$$I < R ;$$
in which, I is the irrigation water volume per unit area; R is available water volume per unit area; and
yield constraint:
$$\sum TWSO \cdot A = {TWSO}^{REG} ;$$
in which, TWSO^{REG} is a food demand in a region where an irrigation area is located.

7. The rolling correction intelligent irrigation decision-making method for a regional wheat-corn rotation system according to claim 1, wherein the step S3 comprises:
S301: applying the regional long-term irrigation program to a study area as a reference long-term irrigation program, and setting the corresponding aboveground biomass under the reference long-term irrigation program as a reference aboveground biomass;
S302: acquiring remote sensing images of an irrigation decision-making region by means of a satellite platform or an unmanned aerial vehicle, and obtaining crop data of aboveground biomass and leaf area index by inversion of a regression model; acquiring real-time soil data by arranging a soil moisture monitor in the irrigation decision-making region; acquiring hydrological data from a long series of runoff monitoring data from a hydrological station; acquiring real-time meteorological data by building a small meteorological station in the irrigation decision-making region; acquiring field management data through real-time input of agricultural management measures by field managers, the agricultural management measures comprising single irrigation volume, irrigation date, fertilization amount, and fertilization date;
S303: at the end of winter wheat harvest or summer corn harvest, exploring the impacts of real-time meteorological condition changes on the phenological periods of wheat and corn by reading the drive data in real time, inputting future meteorological data into the distributed growth localization model of the regional wheat-corn rotation system, and with the goal of maximizing the yield, exploring the optimal sowing date of summer corn or winter wheat;
S304: inputting the real-time drive data into the distributed growth localization model of the regional wheat-corn rotation system; determining whether to correct the reference irrigation program through constraint conditions; redeciding the irrigation program for a grid point that does not meet any of the three constraints; following the reference irrigation program for grid points that meet the constraint conditions; the specific constraint conditions are as follows:
a period biomass constraint:
$$K \cdot Bio \geq {Bio}^{R} ;$$
in which, K is a correction factor; Bio is a period biomass; Bio^{R} is a period biomass under the reference irrigation program;
a water supply constraint:
$${Q}^{S} \geq {Q}^{D} ;$$
in which, Q^{S} is the water supply; Q^{D} is the water demand;
a water demand decision-making error constraint:
$$\frac{\vert {I}^{R} + P - ET \vert}{E T} \leq 8 \% ;$$
in which, I^{R} is a total irrigation volume in the current period, P is a rainfall in the current period; ET is a water demand in the current period; and
S305: redeciding the irrigation program for the next 15 days for a grid that needs to be updated for the irrigation program, solving the model by using a particle swarm algorithm in order to ensure the operating efficiency of the model, and constructing an adaptive correction decision-making model with the goals of maximizing the period biomass and minimizing the water demand decision-making error.
